(19) United States
(12) Patent Application Publication
(10) Pub. No.: US 2026/0183783 A1
(43) Pub. Date: Jul. 2, 2026

(54) CONTROL SYSTEM FOR SPRAYING DEVICE, AND SPRAYING DEVICE

(71) Applicant: XI'AN MUQIN INTELLIGENT TECHNOLOGY CO., LTD., Xian (CN)

(72) Inventors: Xuchao ZHANG, Xian (CN); Xin WANG, Xian (CN); Yaohua QIN, Xian (CN); Mantang LIU, Xian (CN); Wenfeng QIN, Xian (CN)

(21) Appl. No.: 18/869,409

(22) PCT Filed: Jul. 14, 2023
(86) PCT No.: PCT/CN2023/107577

§ 371 Date: Nov. 26, 2024

(30) Foreign Application Priority Data
Jul. 27, 2022 (CN) 202210888768.1

(51) Int. Cl. B05B 12/00; A01G 7/06; A01G 13/10; B05B 7/24; G02B 27/00

(52) U.S. Cl. CPC B05B 12/006; A01G 7/06; A01G 13/10; B05B 7/2489; G02B 27/0006

(57) ABSTRACT

A control system for a spraying device, and a spraying device. A control system includes a controller and one or more bus networks. Each bus network is connected to one or more node devices; the node devices each includes a spraying device; the controller is connected to all the bus networks, so as to communicate with the node devices in the bus networks; the controller is used for: in response to a control operation of a user for the spraying device, transmitting a control signal to a target node device among a plurality of node devices by means of the corresponding bus networks; and the spraying device is used for performing a spraying operation while the target node device operates according to the control signal.

### TECHNICAL FIELD

The present disclosure relates to a field of control technology, particularly relates to a control system for a spraying device and a spraying device.

### BACKGROUND

With continuous development of agricultural technology in our country, a degree of agricultural automation continues to increase. For example, many companies have developed equipments specifically for plowing, spraying, picking, and hoeing. Among them, an spraying operation is an important activity in the crop breeding process. Compared with manual spraying operations, automatic spraying device can greatly increase an efficiency of crop spraying and improve a comprehensiveness of spraying.

However, in current spraying device, node devices in the spraying device are directly connected to the controller. In this setting, as a number of node devices increases, the number of wire harnesses in the spraying device will continue to increase, resulting in the entire weight of the spraying device is relatively great, and the internal wiring of the spraying device will become very complicated, which will bring great inconvenience to the maintenance and update of the spraying device. Moreover, driving methods of existing spraying device are mainly internal combustion engine drive and gasoline-electric hybrid drive, which consume a lot of energy and fuel emissions, causing pollution.

It should be noted that the information disclosed in the above background section is only used to enhance understanding of the background of the present disclosure, and therefore may include information that does not constitute prior art known to those of ordinary skill in the art.

### SUMMARY

The present disclosure provides a control system for spraying device and a spraying device, thereby at least to a certain extent improving problems of excessive wiring harnesses and fuel emission pollution in the prior art of spraying device.

Additional features and advantages of the disclosure will be apparent from the following detailed description, or, in part, may be learned by practice of the disclosure.

According to a first aspect of the present disclosure, a control system for spraying device is provided. The control system includes a controller and one or more bus networks, each of the bus networks connecting to one or more node devices. The node device includes a spraying component. The controller is connected to each of the bus networks to communicate with each of the node devices in each bus network, wherein the controller is configured to transmit control signals to a target node device of the plurality of node devices by a corresponding bus network in response to an user's control operation on the spraying device. The spraying component is configured to perform spraying operations while the target node device operates according to the control signals.

In an exemplary embodiment of the present disclosure, the controller is further configured to send a start signal to the spraying component by the corresponding bus network in response to the user's start operation on the spraying device before spraying operations, so as to enable the spraying component to start spraying.

In an exemplary embodiment of the present disclosure, while the target node device operates according to the control signals, the target node device is further configured to generate operating information, and feedback the operation information to the controller by the corresponding bus network connected to the target node device.

In an exemplary embodiment of the present disclosure, the controller is further configured to parse a signal identifier of the control signals, determine the target node device among the plurality of node devices based on the signal identifier, and transmit the control signal to the target node device by the corresponding bus network of the target node device.

In an exemplary embodiment of the present disclosure, the spraying component includes a liquid storage tank, a water pump with water pump impellers, an air supply assembly and one or more nozzles, the water pump and the liquid storage tank are connected to each other by a guide tube, the water pump and the air supply assembly are connected to the controller by a same bus network or by respective bus networks, wherein the water pump is configured to spray liquid in the liquid storage tank from the one or more nozzles by controlling a rotation speed of the water pump impellers; the air supply assembly is configured to control a spraying area of the liquid sprayed by the one or more nozzles.

In an exemplary embodiment of the present disclosure, the liquid storage tank includes a water tank body and a cover, a water filling port is provided on an upper part of the water tank body, and a water outlet is provided on a lower part of the water tank body; a front end of the water tank body is provided with a front convex platform with a water conduit, a rear end of the water tank body is provided with a rear convex platform with a slot, a bottom of the rear convex platform is provided with a groove, and a reinforcing groove is provided on each surface of the water tank body, the reinforcing groove is configured for increasing a rigidity of the water tank body, and the cover is provided on the water filling port of the water tank body.

In an exemplary embodiment of the present disclosure, the cover includes a cover body and a backstop, the cover body is an integral hollow structure, a side wall of the cover body is provided with threads, and at least one hole is provided on each of an upper side and a lower side of the cover body, the backstop is composed of a connecting nail connected to a middle part of a rubber sheet made of elastomer material; the backstop is connected to a hole on a bottom of the cover body by the connecting nail; wherein at least one convex platform is provided on an upper surface of the cover body; or two symmetrical grooves are provided on the upper surface of the cover body.

In an exemplary embodiment of the present disclosure, the node device further includes a moving module, the moving module includes a body module and a traveling module, the traveling module is installed on two sides of the body module, the liquid storage tank is detachably connected to a vehicle frame of the body module, and a rear end of a front housing of the body module is detachable connected to the front convex platform with the water conduit in the liquid storage tank by setting a rear end groove.

In an exemplary embodiment of the present disclosure, the front housing includes a housing body and a cover plate, the cover panel is movably connected to the housing body; the housing body is a left-right symmetrical hollow cavity, a bottom of the housing body is provided with an air inlet, and a rear portions of two sides of the housing body are respectively provided with side connection recesses, a camera side connection hole is provided on each of a left side and a right side of the side connection recess, a camera with forward view and a camera with rear view are installed in the side connection recess by the camera side connection hole, an air outlet is provided above a middle part of the side connection recess, and a charging port interface is provided in the middle part of the side connection recess; an inner bottom surface of the housing body is provided with a controller installation slot, the controller is located in the controller installation slot, a power supply is connected to a bottom of the controller, the power supply provides power to the control system and is fixedly connected to the vehicle frame; the housing body is further provided with a headlight guide channel.

In an exemplary embodiment of the present disclosure, a buckle is provided on each of the housing body and the cover plate, a sealing strip groove is provided under the cover plate, and a magnet installation groove is provided on each of two sides of the buckle, cover air guide grooves are provided on each of two sides of the cover plate.

In an exemplary embodiment of the present disclosure, the air supply assembly includes an air duct provided with a circular duct, a protective net and an air guiding plate, and a fan is fixedly connected to a side of the air guiding plate, connecting pieces and installation slots are provided on another side of the air guiding plate; the protective net is fixed at an air inlet end of the duct, the air guiding plate is fixedly connected to a lower part of the air duct, and the air supply assembly is connected to the vehicle frame of the body module by the connecting pieces, the mounting groove is inserted into the rear convex platform with a slot at a rear end of the liquid storage tank, and a surface of the air guiding plate equipped with the fan is fixedly connected with a nozzle tube connected to the nozzle; a filter is fixedly connected to a surface of the air guiding plate with a mounting groove, a water inlet pipe of the filter connects the liquid storage tank; a water outlet pipe of the filter is connected to the water pump, the water pump is connected to the nozzle tube.

In an exemplary embodiment of the present disclosure, the air guiding plate is a hollow body formed by a surrounding surface connecting between an installation step surface and an air guiding surface; the installation step surface includes an upper step surface and a lower step surface, a height of the lower step surface is lower than a height of the upper step surface, and an upper edge of the lower step surface is connected to a bottom edge of the upper step surface; a lower end of the air guiding surface is provided with a convex platform configured for connecting to a lower end of the air duct by a bolt, a middle part of the air guiding surface is provided with an air guiding cone with a fan joint on the top, an edge of the air guiding cone is provided with a nozzle installation groove.

In an exemplary embodiment of the present disclosure, the node device further includes a monitoring module, the monitoring module is signally connected to the controller by the bus network, and the monitoring module includes: a liquid level sensor in the liquid storage tank; a water pressure sensor on a pressure port of the water pump; a flow sensor in the guide tube; wherein the controller is further configured to receive input site environment data information to obtain control parameters of the spraying component.

In an exemplary embodiment of the present disclosure, while the target node device operates according to the control signals, the target node device is also configured to generate operating information, and feedback the operation information to the controller by the bus network connected to the target node device.

According to a second aspect of the present disclosure, a spraying device is provided, which includes any one of the above exemplary control system of the spraying devices.

The disclosure has following beneficial effects:

1. According to the control system and spraying device of the spraying device in this exemplary embodiment, the controller can respond to the user's control operation for the spraying device, transmit control signals to the target node device among multiple node devices by the corresponding bus network, and use the spraying device to perform spraying operations while the target node device operates according to the control signals. Using a bus network to connect multiple node devices can facilitate communication between the controller and the node devices, while reducing the number of control wiring harnesses inside the spraying device and lowering maintenance and update costs.

2. According to the liquid storage tank of the spraying device in this exemplary embodiment, the water guide channel can prevent liquid from flowing into the interior of the body module and prevent the liquid from entering the body module and corroding parts.

3. According to the air outlet on the side grooves provided on both sides of the casing body in the front case of the moving module in this exemplary embodiment, it not only serves as a discharge outlet for the heat generated by the equipment installed in the casing body, but also serves as an outlet for the heat generated by the equipment installed in the casing body. The discharged hot air is guided by the air guide groove under the cover and can be blown to the charging port interface and the camera side connection holes provided on both sides of the air outlet, which can reduce or eliminate the water mist and camera ignition of the charging port installed here. fog or dirt.

4. The cover of the liquid storage tank according to the spraying device in this exemplary embodiment has a simple structure, the cover body is relatively difficult to roll, and the integrated hollow structure and backstop make the liquid storage tank have better overflow prevention effect.

5. According to the spraying device in this exemplary embodiment, the conical surface of the air guiding plate of the air supply assembly forms a fan-shaped spray surface under the action of the air duct to spray the pesticide, so that the spray effect is optimal.

It should be understood that the foregoing general description and the following detailed description are exemplary and explanatory only, and do not limit the present disclosure.

### BRIEF DESCRIPTION OF THE DRAWINGS

The accompanying drawings, which are incorporated in and constitute a part of this specification, illustrate embodiments consistent with the disclosure and together with the description, serve to explain the principles of the disclosure. Obviously, the drawings in the following description are only some embodiments of the present disclosure. For those of ordinary skill in the art, other drawings can be obtained based on these drawings without exerting creative efforts.

FIG. 1 shows an architectural view of a control system of a spraying device in an exemplary embodiment.

FIG. 2 shows an architecture view of another control system of spraying device in this exemplary embodiment.

FIG. 3 shows a schematic view of a liquid storage tank viewed from below in this exemplary embodiment.

FIG. 4 shows a perspective view of a front of a liquid storage tank in this exemplary embodiment.

FIG. 5 shows a perspective view of a rear of a liquid storage tank in this exemplary embodiment.

FIG. 6 shows a side view of a connection between a spraying device and a moving module in this exemplary embodiment.

FIG. 7 shows a perspective view of the vehicle body module in FIG. 6.

FIG. 8 shows a perspective view from an angle of FIG. 6 when the crawler track wheel set is not installed.

FIG. 9 shows a perspective view of a connection between the front end of the liquid storage tank and the vehicle frame in this exemplary embodiment.

FIG. 10 shows a perspective view of a connection between the rear end of the liquid storage tank and the vehicle frame in this exemplary embodiment.

FIG. 11 shows a perspective view of an air supply assembly from an angle in this exemplary embodiment.

FIG. 12 shows a perspective view of an air supply assembly from another angle in this exemplary embodiment.

FIG. 13 shows a side view of a backstop in this exemplary embodiment.

FIG. 14 shows a perspective view from a side of the cover body in this exemplary embodiment.

FIG. 15 shows a schematic view of an installation step surface of a wind guiding plate in this exemplary embodiment.

FIG. 16 shows a side view of an air guiding plate in this exemplary embodiment.

FIG. 17 shows a schematic view of an air guiding surface end of an air guiding plate in this exemplary embodiment.

FIG. 18 shows a side view of a housing body of a moving module in this exemplary embodiment.

FIG. 19 shows a schematic view in direction A of FIG. 18.

FIG. 20 shows a perspective view of the housing body of FIG. 18.

FIG. 21 shows a perspective view of a cover plate of a moving module in this exemplary embodiment.

FIG. 22 shows a bottom view of FIG. 21.

FIG. 23 shows a perspective view of a front housing of a moving module in this exemplary embodiment.

FIG. 24 shows a schematic view of a spraying device in this exemplary embodiment.

### DETAILED DESCRIPTION

Example embodiments will now be described more fully with reference to the accompanying drawings. Example embodiments may, however, be embodied in various forms and should not be construed as limited to the examples set forth herein; rather, these embodiments are provided so that this disclosure will be thorough and complete, and will fully convey the concepts of the example embodiments. To those skilled in the art. The described features, structures or characteristics may be combined in any suitable manner in one or more embodiments.

Exemplary embodiments of the present disclosure first provide a control system for spraying device. This system can use a controller to transmit control signals to node devices by the corresponding bus network according to the user's control operations for the spraying device, so that the spraying component in the spraying device can perform spraying operations while the node devices operate according to the above control signals. By using this spraying device, automation of spraying operations can be greatly achieved, so that operators no longer need to use traditional manual spraying methods. Therefore, it can improve the efficiency of spraying operations and reduce labor costs, which is of great significance for promoting agricultural development.

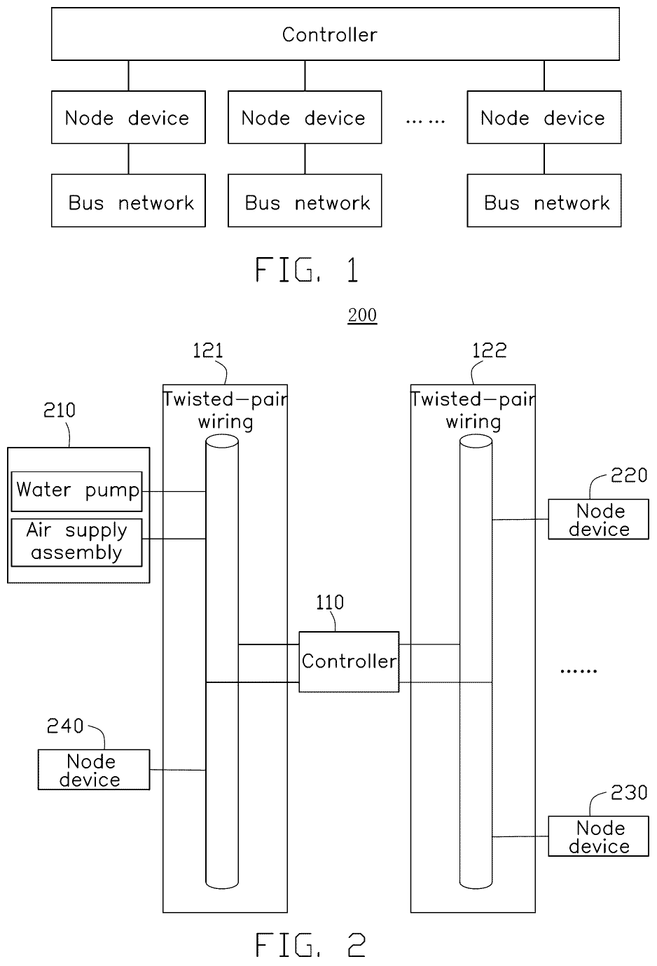

Referring to FIG. 1, the control system of the spraying device in this exemplary embodiment may include a controller, one or more bus networks. Each bus network is connected to one or more node devices, wherein the node device may include a spraying component, and the controller can connect to each bus network to communicate with the node device in each bus network. It should be noted that in the control system of the spraying device as shown in FIG. 1, a number of node devices connected to each bus network is only for illustrative purposes. According to actual needs, each bus network can also be connected to a plurality of node devices. This exemplary embodiment does not impose special limitations on this.

For example, the control system 200 of the spraying device as shown in FIG. 2 may include a controller 110, bus networks 121 and 122, wherein node devices 210 and 240 are node devices connected in the bus network 121, so the node devices 210 and 240 communicate with the controller 110 by the bus network 121, and the node devices 220 and 230 are connected in the bus network 122., so the node devices 220 and 230 can communicate with the controller 110 through the bus network 122.

In this exemplary embodiment, the user can control the spraying device by a control terminal, wherein the control terminal can be a terminal device with a remote control function, such as a remote control, a smart phone, a tablet computer, a desktop computer, a mobile device, etc. The controller can be used to respond to the user's control operation on the spraying device and transmit the control signals to the target node device among the plurality of node devices by the corresponding bus network. The spraying component can be used to perform spraying operations while the target node equipment operates according to control signals. Among them, the controller can refer to a master command device that changes wiring of the main circuit or control circuit and changes resistance value in the circuit in a predetermined order to control starting, speed regulation, braking, and reverse of the motor or control component. The controller can be used to control operation of the spraying component and other node equipment. The bus network can be a controller area network (CAN) bus network, which is a serial communication network that supports distributed control or real-time control. The Node device can be an independent functional unit directly or indirectly connected to the bus network, such as switches, lights, motors, etc.

In an optional embodiment, the controller may be configured to generate control signals of the target node device in response to the user's control operation on the spraying device, and transmit the control signals to the target node device through a bus network corresponding to the target node device. The control signal may include a signal identifier that uniquely identifies a source and a purpose of the control signals. The signal identifier may be defined by the operator or set by default by the system.

In order to achieve the purpose of transmitting the control signals to the target node device, the user can control the spraying device by the control terminal, and the controller can respond to the control operation initiated by the user and generate the control signal for the target node device. Specifically, the controller can determine the target node device according to a type and operation volume of the control operation, and can generate the control signal for the target node device. For example, when the user inputs a number of opened nozzles of the spraying device and the corresponding nozzle code by the control terminal, the controller can generate control signals for the nozzles of the spraying device based on the information input by the user. The control signals may include the number of opened nozzles and the corresponding nozzle code. Then, the controller can transmit the generated control signals to the target node device by the bus network corresponding to the target node device, so that it operates according to the information input by the user. In this way, each node device does not need to separately confirm whether the control signal is transmitted to itself, but only needs to receive the control signals from the target node device.

In an optional embodiment, the controller can also be configured to send a starting signal to the spraying component by the corresponding bus network in response to the user's starting operation of the spraying device before performing the spraying operation, so that the spraying component starts spraying. That is to say, when it is necessary to turn on the spraying function of the spraying device, the controller can, when receiving the starting operation initiated by the user by the control terminal, transmit the starting signal to the spraying component by the bus network connected to the spraying component, thereby controlling the spraying component to start spraying. In this way, a remote spraying control of the spraying device can be achieved, which improves the convenience of controlling the spraying device.

In the above embodiments, the spraying component, as a node device in the bus network, can interact with the controller by the bus network. Compared with the way in which each node device is directly connected to the controller, the bus network can greatly simplify a complexity of the control circuit. degree, reducing the number of wire harnesses.

In an optional embodiment, while the target node device operates according to the control signals, the target node device can also be used to generate operating information, and feedback the operating information to the controller by the bus network connected to the target node device.

For example, in the control system of the spraying device shown in FIG. 2, assuming the target node device is a node device 220, while operating according to the control signals sent by controller 110, the target node device 220 synchronously feeds back the operation information generated during the operation process to controller 110. That is, using the bus network 122 connected to the target node device 220 to feed back the operation information to the controller 110. Thus, the controller can further return operational information to the control terminal operated by the user to further analyze and process operational information, or the controller can directly process operational information to generate new control signals, thereby improving real-time control of the node devices.

In an optional embodiment, the controller is configured to parse the signal identification of the control signal, determine the target node device among the plurality of node devices according to the signal identification, and transmit the control signals to the target node device by the bus network corresponding to the target node device. Specifically, the controller can parse the control signals and obtain the signal identifier in the control signals, thereby determining the target node device among the plurality of node devices based on the signal identifier. For example, when the user inputs a control signal containing a number of activated nozzles and a corresponding nozzle code by the control terminal, the controller analyzes the control signal and obtains a signal identification including the number of activated nozzles and the nozzle code. The controller can then determine the target node device based on the nozzle code.

In an optional embodiment, the spraying component may include a liquid storage tank, a water pump with water pump impellers, an air supply assembly, and one or more sprinkler heads, wherein the water pump and the liquid storage tank may be connected by a guide tube. The water pump and the air supply assembly can be connected to the controller by same or different bus networks. Specifically, the water pump can be used to spray the liquid in the liquid storage tank from one or more nozzles by controlling the rotation speed of the water pump impellers. The air supply assembly can be used to control the spray pattern of the liquid ejected by one or more nozzles. For example, in the control system as shown in FIG. 2, the water pump and air supply assembly in the spraying component 210 are connected to the controller 110 by the bus network 121. When the user controls the spraying component 210 to run or stop running, the controller 110 can send signals to the water pump and air supply assembly in the spraying component 210 by the bus network 121 to start or stop operation of the water pump and the air supply assembly.

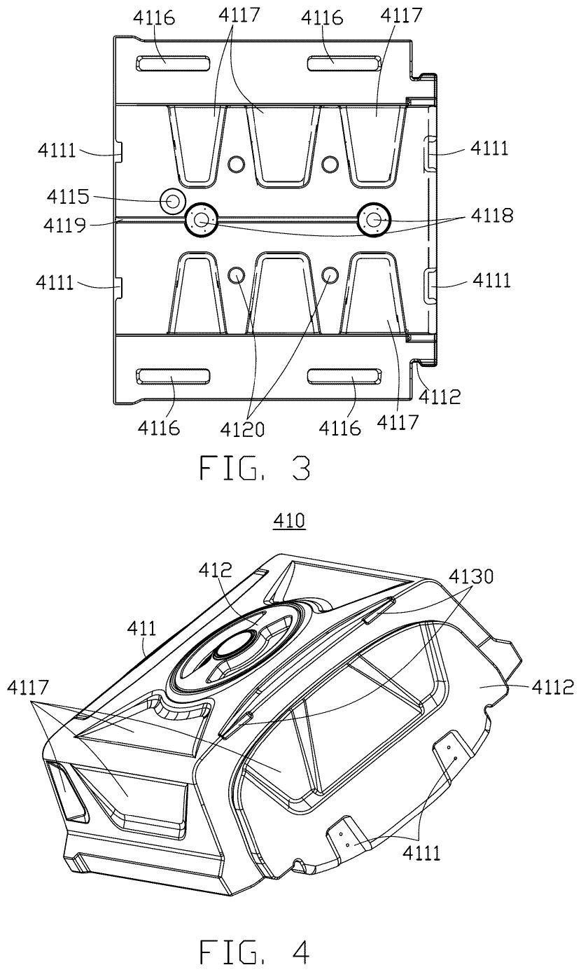

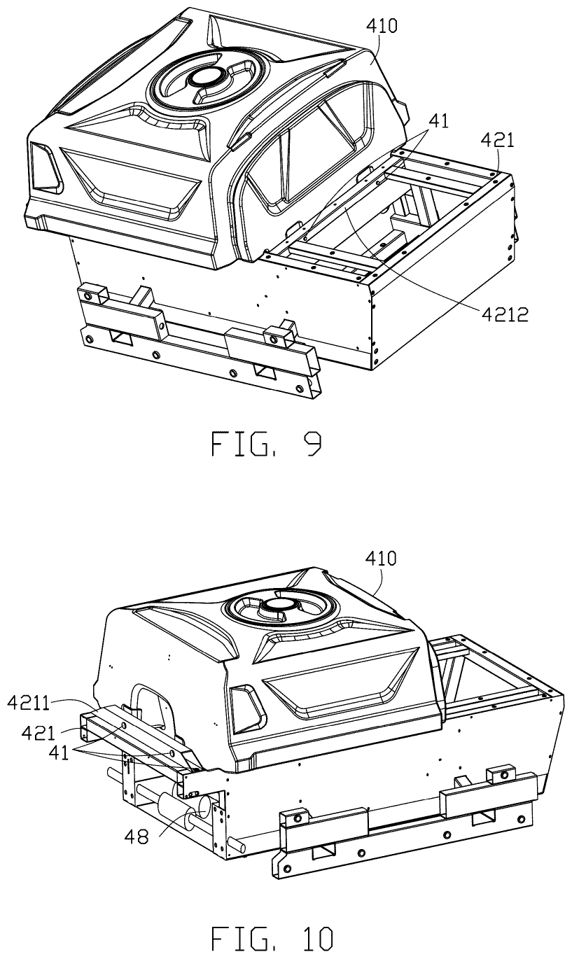

In an optional embodiment, referring to FIG. 3, FIG. 4, FIG. 5, FIG. 9 and FIG. 10, the liquid storage tank 410 includes a water tank body 411 and a cover 412. A water filling port is defined in an upper part of the water tank body 411, and the cover 412 is located on the water filling port of the water tank body 411. The upper part of the water tank body 411 is also provided with a reinforcement groove 4117 and an avoidance groove 4130. The lower part of the water tank body 411 is provided with a water outlet 4115, two liquid level sensor connection holes 4118, and a wire trough 4119, four blind holes 4120, buckles 4116 and reinforced slots 4117. There are also reinforced slots 4117 on side walls of the water tank body 411. The reinforced slots 4117 are used to improve rigidity of the water tank body 411. At the front end of the water tank body 411, there is a front convex platform 4112 with a water guide groove, and at the rear end, there is a rear convex platform 4114 with a card groove 4113. A bottom of the rear convex platform 4114 is provided with a groove. A front end and a rear end of the water tank body 411 are composed of embedded nuts 4111. The embedded nuts 4111 can be connected to the fixed beam 4212 and a detachable beam 4211 of the vehicle frame 421 (refer to FIG. 9 and FIG. 10) through bolts 41, so as to fix the liquid storage tank 410 to the vehicle frame 421. The avoidance groove 4130 can be selected to prevent interference between the water tank body 411 and adjacent components. The two liquid level sensor connection holes 4118 can be selected to install the liquid level sensor, and the wire trough 4119 can be selected to arrange line, which can be connected to the liquid level sensor. The four blind holes 4120 can be selected for installing support leg of the liquid storage tank.

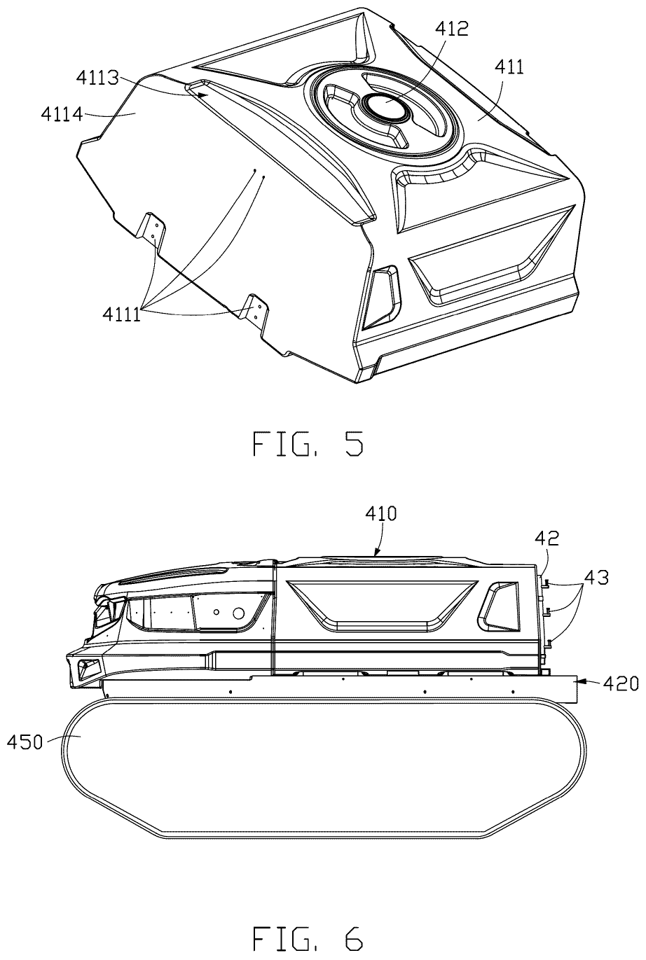

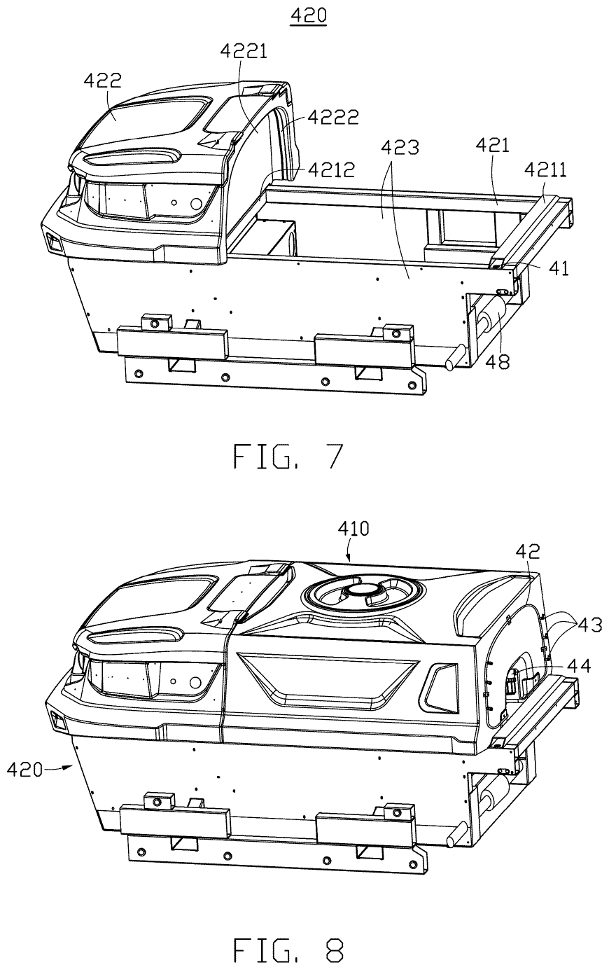

In an optional embodiment, referring to FIGS. 6, 7, 8, 9, and 10, the node device further includes a moving module. The spraying component is arranged on the moving module, and the moving module is used to drive the spraying component to move. The moving module includes a body module 420 and a traveling module. The traveling module is wheels or track traveling wheel set 450. The track traveling wheel set 450 is installed on both sides of the body module 420. The body module 420 includes a vehicle frame 421 providing with a fixed beam 4212 and a detachable beam 4211, a protective plate 423 fixed on outside of the vehicle frame 421, a driving module 48 arranged behind the vehicle frame 421, a front housing 422 containing power modules such as a control module. The front housing 422 is fixed on an end of the vehicle frame 421, a rear end of the front housing 422 is provided with a rear end groove 4221 that can connect to one end of the liquid storage tank 410. The water pump of the spraying component is fixedly connected to the vehicle frame 421 of the body module 420. The liquid storage tank 410 can be detachably connected to the vehicle frame 421 of the body module 420.

It can be understood that in other optional embodiments, the moving module includes a body module, wheels or track traveling wheel set, the wheels or the track traveling wheel set set are installed on both sides of the body module, and the water pump is fixed on the vehicle frame of the body module. The front and rear ends of the liquid storage tank can be detachably connected to the vehicle frame by providing embedded nuts or L-shaped connectors, and the convex platform with the guide channel at the front end of the liquid storage tank is embedded in the rear end groove of the front housing.

It can be understood that in other optional embodiments, when joints at the front and rear ends of the liquid storage tank are both L-shaped connectors, the liquid storage tank with its water outlet facing towards the vehicle frame is placed until two sides of the liquid storage tank on both sides of the frame's longitudinal beams. Then push the liquid storage tank forward to its front end secure to the fixed beam at the front of the vehicle frame. Then, press the L-shaped connector at the rear end of the liquid storage tank by the detachable beam, and fix the two ends of the detachable beam to the side longitudinal beams on both sides of the vehicle frame with bolts to achieve fixed connection of the liquid storage tank on the vehicle frame. In addition, the connection of cameras, various sensors and other accessories on the moving module is the same as that of other existing plant protection machinery, which is also a common processing method for technicians in the field of plant protection machinery and equipment, and will not be described again here.

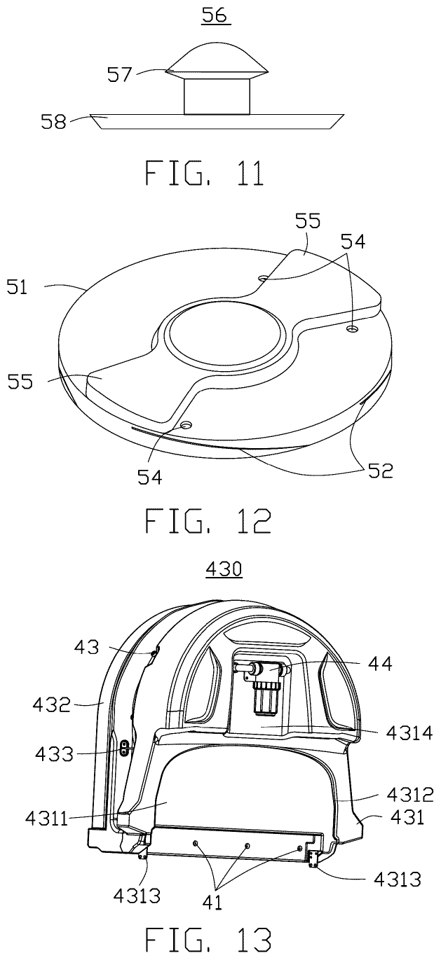

In an optional embodiment, referring to FIGS. 11 and 12, the cover on the upper part of the water tank body includes a cover body 51 and a backstop 56. The cover body 51 is an integral hollow structure, and side wall of the cover body 51 is provided with threads 52. At least one hole 54 is provided in each of an upper surface and a lower surface of the cover body 51. The backstop 56 is composed of a connecting nail 57 connected to a middle part of a rubber sheet 58 made of elastomer material. The backstop 56 is connected to the hole 54 of the cover body 51 by the connecting nail 57. The backstop 56 is formed by fixedly connecting one side of the disc-shaped rubber sheet 58 to a lower end of the connecting nail 57.

In an optional embodiment, the cover body 51 is provided with four holes 54 and a convex platform 55 on the upper surface. The upper four holes 54 are used for ventilation, and the lower is provided with five holes. A middle hole of the lower five holes is used to install the backstop 56, and the remaining four holes are used for ventilation. The convex platform 55 facilitates twisting, removal or installation of the cover at the water filling port of the liquid storage tank. Specifically, the way of installing the backstop 56 to the cover body 51 is to insert an upper part of the backstop 56 into the middle hole on the bottom of the cover body 51.

In an optional embodiment, two symmetrical grooves are provided on the cover body, and the grooves facilitate the twisting, removal or installation of the cover at the water filling port of the liquid storage tank.

When using the cover, place the cover with the backstop 56 facing the water filling port of the liquid storage tank and place it on the water filling port of the liquid storage tank. Hold the convex platform 55 or protrusion between the grooves on the cover, rotate clockwise to tighten the cover, rotate counterclockwise to remove the cover. The cover can enable the liquid storage tank to realize anti-overflow function. The anti-overflow principle is to ensure smooth air intake in the liquid storage tank by the backstop 56, and at the same time prevent the liquid stirred by shaking from flowing out of the hole 54 on the cover body 51. In addition, a cavity in the hollow cover body 51 buffers the liquid that once overflows the backstop 56 and flows back into the liquid storage tank, thereby preventing overflow with double insurance.

In an optional embodiment, the backstop 56 prevents overflow, and air outside can flow from the upper hole 54 of the cover body 51 into the lower hole 54, further pushing the rubber sheet 58 on the backstop 56, and from a gap between the rubber sheet 58 and the bottom of the cover body 51 enters the water tank. However, shaken liquid hits the backstop 56 and presses the rubber sheet 58 on the hole 54 below the cover body 51 to prevent the liquid in the liquid storage tank from overflowing and realize anti-overflow of the backstop 56.

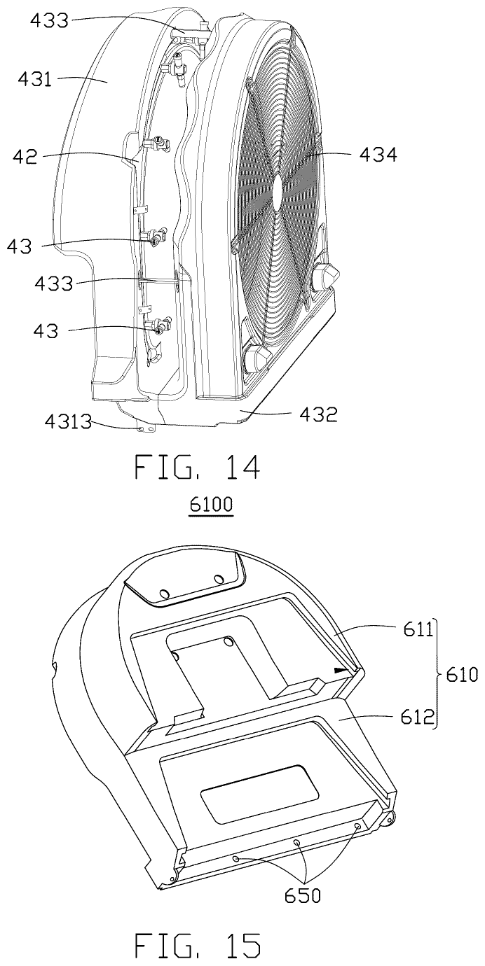

In an optional embodiment, referring to FIG. 13 and FIG. 14, the air supply assembly 430 includes an air duct 432 provided with a circular duct, a protective net 434 and an air guiding plate 431. One side of the air guiding plate 431 is fixed a fan, and the other side is provided with a connecting piece 4313, a first installation slot 4311 and a second installation slot 4314. The first installation slot 4311 and the second installation slot 4314 are installation slots defined in other side of the air guiding plate 431. The protective net 434 is fixed to an air inlet end of the air duct 432, the air guiding plate 431 and the lower part of the air duct 432 are fixedly connected by bolts 41, and the air channel formed between the air guiding plate 431 and the air duct 432 is provided with a connector 433. The air supply assembly 430 is connected to the rear convex platform 4114 of the liquid storage tank 410 with a card slot 4113 by the tank connection groove 4312 in the first installation groove 4311 on the air guiding plate 431, and is fixed to the vehicle frame 421 with bolts 41 through the connecting piece 4313 at a lower part of the air guiding plate 431. A surface of the air guiding plate 431 provided with the fan is fixedly connected to the nozzle tube 42 connected to the nozzle 43. A surface of the air guiding plate 431 having the second mounting slot 4314 is fixed a filter 44. The filter 44 is fixedly fixed in the second installation groove 4314 of the air guiding plate 431 by screws and other connecting parts. The water inlet pipe of the filter 44 is used to connect the liquid storage tank, and the water outlet pipe of the filter 44 is connected to the water pump. The water pump is connected, and the water pump is connected to the nozzle tube 42. The liquid in the liquid storage tank is sent to the nozzle 43 by the filter, the water pump, and nozzle tube 42. Under the control of the controller, the air flow generated by rotation of the fan is blown out from a gap between the air duct 432 and the air guiding plate 431, and carries liquid droplets sprayed from the nozzle 43, achieving more efficient and uniform plant protection operations. Among them, the filter 44 is detachably connected between the liquid storage tank and the water pump. The filter 44 is used to filter the pesticide residue and achieve smooth spraying of the nozzle 43.

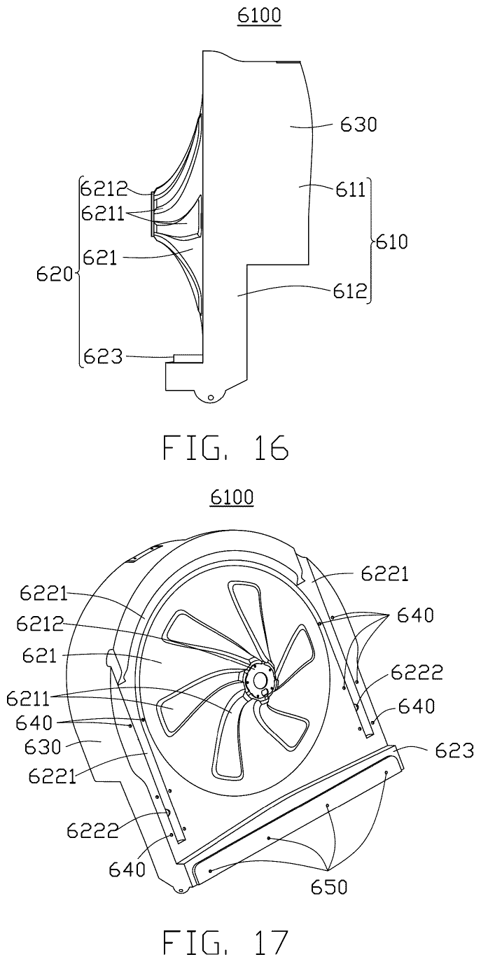

In an optional embodiment, referring to FIG. 15, FIG. 16, and FIG. 17, an air guiding plate 6100 is a hollow body formed by a surrounding surface 630 connected between the installation step surface 610 and the air guiding surface 620. It can be produced by blow molding of plastic materials such as high-density polyethylene or polycarbonate.

The installation step surface 610 includes an upper step surface 611 and a lower step surface 612. A height of the lower step surface 612 is lower than that of the upper step surface 611. An upper edge of the lower step surface 612 is connected to a bottom edge of the upper step surface 611. The lower step surface 612 has at least two bolt holes 650 for connecting the air duct.

A lower end of the air guiding surface 620 is provided with a convex platform 623 for connecting the lower end of the air duct by bolts. A middle part of the air guiding surface 620 is provided with an air guiding cone 621. A top of the air guiding cone 621 is provided with a fan joint 6212, surrounding surface is provided with flow ridges 6211, and an edge of the air guiding cone 621 are provided with a nozzle installation groove 6221. The nozzle installation groove 6221 is provided with a nozzle insertion hole 6222, and screw holes 640 are provided on both sides for fastening the connector and the pressing piece.

An optional embodiment of the air supply assembly is described as follows: the air supply assembly includes an air duct, a connector, a pressing plate, a filter, a nozzle, a fan, a lamp, a protective net and an air guiding plate as mentioned above. A lower end surface of an air outlet of the air duct is connected to a lower end of the air guiding plate by bolts. The connecting piece is fixed between the air outlet end surface of the air duct and the air guiding surface. The filter is detachably connected to the installation step surface by screws, and the water inlet pipe of the filter is used to connect the water outlet of the liquid storage tank, the water outlet pipe of the filter is connected to the water pump, the tube body of the nozzle tube is fixed in the nozzle installation groove by one end of the connector and/or the pressing piece, and the fan is fixed on the fan connector at the top of the air guiding cone by a motor of the fan. The protective net is fixed on the air inlet end of the air duct by screws. The light is set on the enclosure and/or the air duct. The fan is selected to be a direct-driven motor fan.

The air supply assembly is connected to the moving module for use. When it is necessary to carry out pesticide spraying operations in orchards with low growing fruit trees, the upper step surface of the air guiding plate on the air supply assembly is inserted from top to bottom into the corresponding rear convex platform with a card slot on the liquid storage tank, and then the lower end of the air guiding plate is fixed to the screw hole on the vehicle frame with screws. When it is necessary to apply pesticides in orchards with tall fruit trees, the lower step surface of the air guiding plate on the air supply assembly is inserted from top to bottom into the corresponding rear convex platform with a card slot on the liquid storage tank, and then the lower end of the air guiding plate is fixed to the screw hole on the vehicle frame with screws.

The upper air guiding surface of the air guiding plate of the present disclosure is easy to make into an arc shape, so that compared with a general straight-face air guiding plate, it can reduce scratch damage to branches and fruits. The installation step surface of the air guiding plate adopts a stepped-shape design, whether the air guiding plate is installed at a high or low position of the platform such as vehicle frame and/or the liquid storage tank, the weight of the air guiding plate can be supported by the step surface to ensure that the installation of the air guiding plate is stable and reliable. When adjusting installing height of the air supply assembly on a fixed object, only the insert-in position on the installation step of the air guiding plate is needed to change, which is easy to adjust. The air deflector is made of plastic material, which is not only easy to design, but also has high mass production efficiency and low cost.

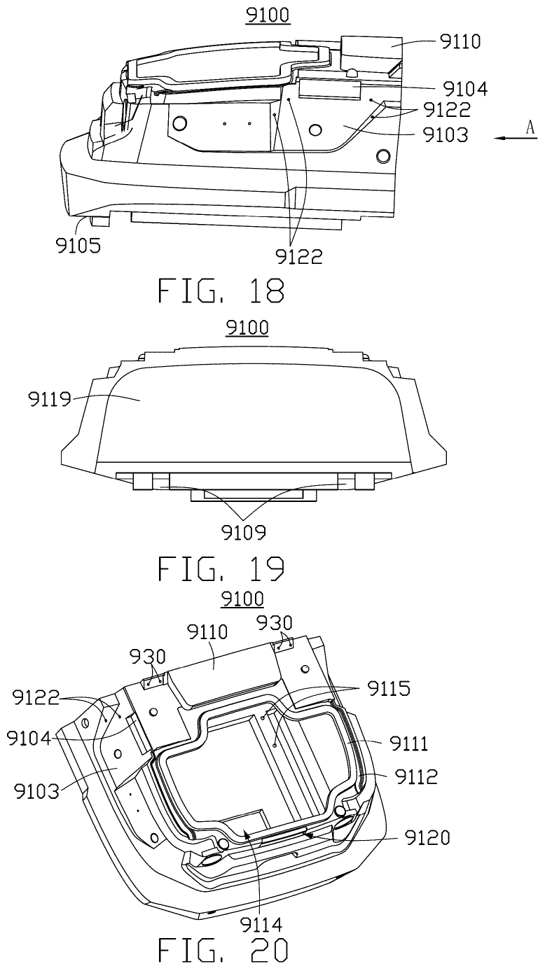

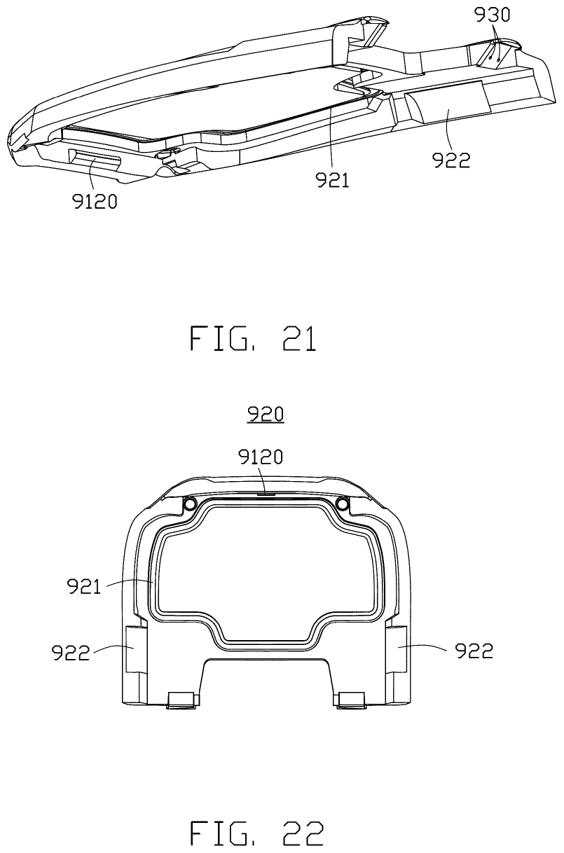

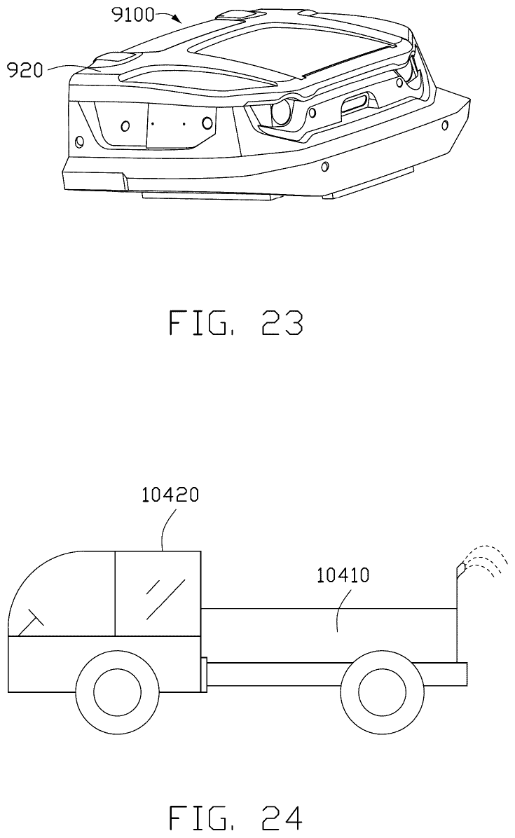

In an optional embodiment, referring to FIGS. 18, 19, 20, 21, 22, and 23, the front housing of the body module includes a housing body 9100 and a cover plate 920. The cover plate 920 is connected to the housing body 9100 in a movable manner. The housing body 9100 is a symmetrical hollow cavity made by blow molding high-density polyethylene or polycarbonate plastics. The housing body 9100 is equipped with an air outlet 9104, an air inlet 9105, a vehicle frame installation groove 9109, a convex cavity 9110, a water blocking convex edge 9111, a water guide groove 9112, a power fixing bracket installation groove 9114, and a controller installation slot 9115. The air inlet 9105 is located at the bottom of the housing body 9100, and air enters through the air inlet 9105 and is discharged from the air outlet 9104 for heat dissipation. The water guide groove 9112 is located on outer circumference of the water blocking convex edge 9111, and the convex cavity 9110 is located behind the water guide groove 9112 for installing antennas and other equipment. The power fixing bracket installation groove 9114 and the controller installation slot 9115 are located at the internal bottom of the housing body 9100. The controller is located in the controller installation slot 9115. A bottom of the controller is connected to a power supply. The power supply is fixedly attached to the vehicle frame to provide power to the entire system. The vehicle frame installation groove 9109 is located at the bottom of the housing body 9100. The overlap groove 9119 is located at a rear end of the housing body 9100, used to connect to one end of the liquid storage tank installed on the moving module. The rear of two sides of the housing body 9100 also has side connection recesses 9103, and there are camera side connection holes 9122 on both sides of the side connection recesses 9103. Each side connection recess 9103 is equipped with a forward view and a backward view camera through its camera side connection hole 9122. There is an air outlet 9104 above a middle of the side connection recess 9103, the side connection recess 9103 can protect the camera. The air outlet 9104 is used to blow away dust and water vapor on the camera. Among them, the power supply can be electrically connected to the controller, the water pump, the air supply assembly (fans, lights, etc.), and vehicle module to provide power for the controller, the water pump, the air supply assembly, and the body module, thereby providing power for the entire control system.

Under these conditions, the control system and the node device adopt pure electric drive, which has advantages of low energy consumption, no pollution, lightweight, and environmental protection. Due to the pure electric drive, it can reduce emission of pollutants caused by the use of fuel. In addition, use of pure electric drive can reduce the weight of the node device, making the control system more precise in controlling the node device, especially the body module, and improve the mobility accuracy of the body module.

Optional embodiments are now described as follows. (1). The housing body is also provided with a headlight guide groove, and the headlight guide groove is located at an upper part of the headlight installation hole. (2). The housing body 9100 is also provided with a buckle 9120, and the buckle 9120 is located on the front end of the housing body 9100.

In an optional embodiment, a groove 921 for installing a sealing strip is provided in the middle of a lower surface of the cover plate 920, a buckle 9120 is provided in the middle of the front end of the lower surface of the cover plate 920, and air guiding slots 922 are provided on both sides of the lower surface of the cover plate 920, a nut 930 is embedded in a rear end of the cover plate 920. The nut 930 is used to connect the hinge. The rear end of the cover plate 920 is connected to the top of the housing body 9100 by hinge to achieve movable connection with the housing body 9100. The cover plate 920 can be tightly closed on the housing body 9100 by the buckle 9120. The front housing is used to be fixed on the vehicle frame of the moving module through the vehicle frame mounting groove 9109 at the bottom of the front housing, to provide an installation platform and waterproof and anti-collision protection for power modules such as the control module of the moving module.

A principle of anti-fogging and reducing contamination of the camera lens when the front housing is used in the moving module: when the front housing is used in the moving module for operation, the heat generated by the control module and other power modules installed in the housing body 9100 is discharged from the air outlet 9104 on the side connection recess 9103 is by the fan, and then the relatively dry hot air flow discharged from the air outlet 9104 is guided by the air guiding slot 922 on an inner side of the cover 920 to blow hot air to the charging port and the cameras installed on both sides of the air outlet 9104, and the fog on the lens is blown dry. At the same time, airflow passing through the camera will blow away the dust, flying insects, small droplets and other pollutants close to the camera, thereby keeping the camera in good display effect for a longer time, reducing cleaning frequency of the camera, improving efficiency of plant protection operations, and avoiding operational accidents caused by display interference. When the front housing is used in the moving module, when it is necessary to inspect and maintain components inside the housing body 9100, the front end of the cover plate 920 can be grasped by hand and lifted up with force to open it (lifting up to disengage the buckle 9120 and/or magnet on the shell body 9100 from the corresponding buckle 9120 and/or magnet on the cover plate 920). After the inspection and maintenance are completed, the cover plate 920 can be lowered again and fastened onto the housing body 9100.

In an optional embodiment, the moving module can be connected to any bus network to communicate with the controller. Based on this, the controller can also be used to send movement signals to the moving module through any bus network connected to the moving module. The moving module can move forward or backward according to the movement signals sent by the controller, and can also stop or start moving according to the movement signals. While the spraying component is working, the controller can also respond to the user's movement operation of the moving module by sending a movement signal to the moving module through any bus network connected to the moving module, so that the moving module can drive the spraying component to move according to the movement signals, achieving mobile spraying operation, improving the flexibility and applicability of the spraying component, and meeting the spraying needs in different scenarios.

In an optional embodiment, the controller can receive operation data from the moving module and the spraying component by any bus network, enabling collection of operation data and environmental data. These data can be used to display operation status of the node device on the controller, providing reliable data references for users. Meanwhile, these data can also serve as a basis for subsequent analysis and optimization of spraying operations.

In an optional embodiment, the controller can also be used to respond to received operation data of the moving module, and when the moving module stops moving, it can control the spraying component to power off the water pump and the air supply assembly. When the moving module is started, control the spraying component to power on the water pump and the air supply assembly.

Under these conditions, once the moving module stops moving, the spraying component will stop spraying, so it will not cause repeated spraying in the same area, which can effectively save liquid volume and reduce waste. When the moving module is started, it will automatically turn on the water pump and the air supply assembly, realizing automatic start and stop of the spraying component, which can improve work efficiency and reduce resource waste.

In an optional embodiment, the node device also includes a monitoring module. The monitoring module is signal connected to the controller signal by any bus network. The monitoring module includes a liquid level sensor, a water pressure sensor and a flow sensor. The liquid level sensor is arranged in the liquid storage tank. The water pressure sensor is installed on a pressure port of the water pump, and the flow sensor is installed in a guide tube connected to the liquid storage tank and the water pump. The controller is also used to receive input site environment data information to obtain control parameters of the spraying component. During operation, the monitoring module feeds back each sensor data to the controller in real time, and the controller performs calculation and adjustment to achieve variable control of the water pump and the air supply assembly after obtaining the feedback data. Specifically, the site environment data includes spraying area, tree spacing, row spacing and other information. The control parameters of the spraying device include water pump impeller adjustment speed, moving module operating speed, number of the nozzles and other parameters. Spraying operation can be accurately controlled in real time according to the site conditions.

Under this condition, the controller can promptly perform variable control on the water pump and the air supply assembly of the spraying component according to the water level in the liquid storage tank, the water pressure of the water pump, and the flow rate in the guide tube, so the spraying component will not continue to spray when at least one of the water level, water pressure, and flow rate does not meet the requirements, avoiding situations where the spraying component is unloaded. When at least one of the water level, the water pressure, and the flow rate does not meet the requirements, the spraying component can be checked in a timely manner to determine a specific problem, achieving effective protection of the spraying device.

In summary, according to the control system of the spraying device in this exemplary embodiment, the controller can respond to the user's control operation on the spraying component and transmit the control signals to the target node device among the multiple node devices by the corresponding bus network. The spraying device is used to perform spraying operations while the target node device operates according to the control signals. Using the bus network to connect the multiple node devices can facilitate communication between the controller and the node devices. It can also reduce the number of control circuit harnesses inside the spraying device and reduce a maintenance and update costs of the spraying device.

This exemplary embodiment also provides a spraying apparatus, which includes the above-mentioned control system of the spraying device. Referring to FIG. 24, the spraying device includes a spraying component 10410 and a moving module 10420. At this time, the moving module 10420 can be a vehicle. The spraying component 10410 is stably installed on the moving module 10420. A sprinkler head is installed at the rear of the spraying component 10410, which can spray according to the user's control operation during vehicle movement. However, it should be understood that the spraying vehicle shown in FIG. 24 is only a schematic view of the spraying device in this exemplary embodiment. Depending on the operation scenario and research and development needs, the spraying device should be a professional spraying vehicle or a professional sprayer for agricultural applications, etc. The examples herein should not limit the scope of the present disclosure. Specifically, the specific details of each module in the control system of the above-mentioned spraying device have been described in detail in the above-mentioned embodiments. For details of undisclosed solutions, please refer to the above-mentioned embodiments, so they will not be described again.

With continuous improvement of agricultural mechanization, quality requirements for various operating equipment are becoming higher and higher. Therefore, it is more necessary to set up a more reasonable and stable control system. Using the control system of the above spraying device can not only reduce the number of wiring harnesses inside the spraying device, but also bring great benefits to subsequent maintenance, updates and upgrades of the spraying device, such as locating faults of the spraying device, expanding new functional modules, can bring great convenience.

The preferred exemplary embodiments of the present disclosure have been described above in conjunction with the accompanying drawings. However, it should be understood that the present disclosure is not limited to the specific details of the above-mentioned embodiments. Within the scope of the technical concept of the present disclosure, the technical solutions of the present disclosure can be modified in many ways. Simple modifications, these simple modifications all belong to the protection scope of the present disclosure.

Other embodiments of the present disclosure will be readily apparent to those skilled in the art from consideration of the specification and practice of the invention disclosed herein. This application is intended to cover any variations, uses, or adaptations of the disclosure that follow the general principles of the disclosure and include common knowledge or customary technical means in the technical field that are not disclosed in the disclosure. It is intended that the specification and embodiments be considered as exemplary only, with a true scope and spirit of the disclosure being indicated by the following claims.

1. A control system for a spraying device, comprising:
a controller;
one or more bus networks; and
one or more node devices, each of the bus networks connecting to one or more node devices, and the node device comprising a spraying component, the controller connecting to each of the bus networks to communicate with each node device,
wherein the controller is configured to transmit control signals to a target node device of the one or more node devices by a corresponding bus network of the one or more bus networks in response to a control operation on the spraying device;
the spraying component is configured to perform spraying operations while the target node device operates according to the control signals.

2. The control system of claim 1, wherein the controller is further configured to send a start signal to the spraying component by the corresponding bus network in response to a start operation on the spraying device before the spraying component performing the spraying operations, so as to enable the spraying component to start spraying.

3. The control system according to claim 1, wherein while the target node device operates according to the control signals, the target node device is further configured to generate operating information, and feedback the operation information to the controller by the corresponding bus network connected to the target node device.

4. The control system of claim 1, wherein the controller is further configured to parse a signal identifier of the control signals, determine the target node device among the plurality of node devices based on the signal identifier, and transmit the control signal to the target node device by the corresponding bus network of the target node device.

5. The control system according to claim 1, wherein the spraying component comprises a liquid storage tank, a water pump with water pump impellers, an air supply assembly and one or more nozzles, the water pump and the liquid storage tank are connected to each other by a guide tube, the water pump and the air supply assembly are connected to the controller by a same bus network or by respective bus networks,
wherein the water pump is configured to spray liquid in the liquid storage tank from the one or more nozzles by controlling a rotation speed of the water pump impellers;
the air supply assembly is configured to control a spraying area of the liquid sprayed by the one or more nozzles.

6. The control system according to claim 5, wherein the liquid storage tank comprises a water tank body and a cover, a water filling port is provided on an upper part of the water tank body, and a water outlet is provided on a lower part of the water tank body; a front end of the water tank body is provided with a front convex platform with a water conduit, a rear end of the water tank body is provided with a rear convex platform with a slot, a bottom of the rear convex platform is provided with a groove, and a reinforcing groove is provided on each surface of the water tank body, the reinforcing groove is configured for increasing a rigidity of the water tank body, and the cover is provided on the water filling port of the water tank body.

7. The control system of claim 6, wherein the cover comprises a cover body and a backstop, the cover body is an integral hollow structure, a side wall of the cover body is provided with threads, and at least one hole is provided on each of an upper side and a lower side of the cover body, the backstop comprises a connecting nail and a rubber sheet made of elastomer material, the connecting nail connected to a middle part of the rubber sheet; the backstop is connected to a hole on a bottom of the cover body by the connecting nail; wherein at least one convex platform is provided on an upper surface of the cover body; or two symmetrical grooves are provided on the upper surface of the cover body.

8. The control system of claim 6, wherein the node device further comprises a moving module, the moving module comprises a body module and a traveling module, the traveling module is installed on two sides of the body module, the liquid storage tank is detachably connected to a vehicle frame of the body module, and a rear end of a front housing of the body module is detachable connected to the front convex platform with the water conduit in the liquid storage tank by setting a rear end groove.

9. The control system according to claim 8, wherein the front housing comprises a housing body and a cover plate, the cover panel is movably connected to the housing body; the housing body is a left-right symmetrical hollow cavity, a bottom of the housing body is provided with an air inlet, and a rear portions of two sides of the housing body are respectively provided with side connection recesses, a camera side connection hole is provided on each of a left side and a right side of the side connection recess, a camera with forward view and a camera with rear view are installed in the side connection recess by the camera side connection hole, an air outlet is provided above a middle part of the side connection recess, and a charging port interface is provided in the middle part of the side connection recess; an inner bottom surface of the housing body is provided with a controller installation slot, the controller is located in the controller installation slot, a power supply is connected to a bottom of the controller, the power supply provides power to the control system and is fixedly connected to the vehicle frame; the housing body is further provided with a headlight guide channel.

10. The control system of claim 9, wherein a buckle is provided on each of the housing body and the cover plate, a sealing strip groove is provided under the cover plate, and a magnet installation groove is provided on each of two sides of the buckle, air guide grooves are provided on each of two sides of the cover plate.

11. The control system according to claim 8, wherein the air supply assembly comprises an air duct provided with a circular duct, a protective net and an air guiding plate, and a fan is fixedly connected to a side of the air guiding plate, connecting pieces and installation slots are provided on another side of the air guiding plate; the protective net is fixed at an air inlet end of the duct, the air guiding plate is fixedly connected to a lower part of the air duct, and the air supply assembly is connected to the vehicle frame of the body module by the connecting pieces, the mounting groove is inserted into the rear convex platform with a slot at a rear end of the liquid storage tank, and a surface of the air guiding plate equipped with the fan is fixedly connected with a nozzle tube connected to the nozzle; a filter is fixedly connected to a surface of the air guiding plate with a mounting groove, a water inlet pipe of the filter connects the liquid storage tank; a water outlet pipe of the filter is connected to the water pump, the water pump is connected to the nozzle tube.

12. The control system according to claim 11, wherein the air guiding plate is a hollow body formed by a surrounding surface connecting between an installation step surface and an air guiding surface;
the installation step surface comprises an upper step surface and a lower step surface, a height of the lower step surface is lower than a height of the upper step surface, and an upper edge of the lower step surface is connected to a bottom edge of the upper step surface; a lower end of the air guiding surface is provided with a convex platform configured for connecting to a lower end of the air duct by a bolt, a middle part of the air guiding surface is provided with an air guiding cone with a fan joint on the top, an edge of the air guiding cone is provided with a nozzle installation groove.

13. The control system of claim 5, wherein the node device further comprises a monitoring module, the monitoring module is signally connected to the controller by the bus network, and the monitoring module comprises:
a liquid level sensor in the liquid storage tank;
a water pressure sensor on a pressure port of the water pump;
a flow sensor in the guide tube;
wherein the controller is further configured to receive input site environment data information to obtain control parameters of the spraying component.

14. A spraying device, comprising a control system; the control system comprising:
a controller;
one or more bus networks; and
one or more node devices, each of the bus networks connecting to one or more node devices, and the node device comprising a spraying component, the controller connecting to each of the bus networks to communicate with each node device,
wherein the controller is configured to transmit control signals to a target node device of the one or more node devices by a corresponding bus network of the one or more bus networks in response to a control operation on the spraying device;
the spraying component is configured to perform spraying operations while the target node device operates according to the control signals.

15. The spraying device of claim 14, wherein the controller is further configured to send a start signal to the spraying component by the corresponding bus network in response to a start operation on the spraying device before the spraying component performing the spraying operations, so as to enable the spraying component to start spraying.
while the target node device operates according to the control signals, the target node device is further configured to generate operating information, and feedback the operation information to the controller by the corresponding bus network connected to the target node device.
the controller is further configured to parse a signal identifier of the control signals, determine the target node device among the plurality of node devices based on the signal identifier, and transmit the control signal to the target node device by the corresponding bus network of the target node device.

16. The spraying device of claim 14, wherein the spraying component comprises a liquid storage tank, a water pump with water pump impellers, an air supply assembly and one or more nozzles, the water pump and the liquid storage tank are connected to each other by a guide tube, the water pump and the air supply assembly are connected to the controller by a same bus network or by respective bus networks,
wherein the water pump is configured to spray liquid in the liquid storage tank from the one or more nozzles by controlling a rotation speed of the water pump impellers;
the air supply assembly is configured to control a spraying area of the liquid sprayed by the one or more nozzles.

17. The spraying device of claim 16, wherein the liquid storage tank comprises a water tank body and a cover, a water filling port is provided on an upper part of the water tank body, and a water outlet is provided on a lower part of the water tank body; a front end of the water tank body is provided with a front convex platform with a water conduit, a rear end of the water tank body is provided with a rear convex platform with a slot, a bottom of the rear convex platform is provided with a groove, and a reinforcing groove is provided on each surface of the water tank body, the reinforcing groove is configured for increasing a rigidity of the water tank body, and the cover is provided on the water filling port of the water tank body.

18. The spraying device of claim 17, wherein the cover comprises a cover body and a backstop, the cover body is an integral hollow structure, side wall of the cover body is provided with threads, and there is at least one hole on each of an upper side and a lower side of the cover body, the backstop comprises a connecting nail and a rubber sheet made of elastomer material, the connecting nail connecting to a middle part of the rubber sheet; the backstop connects to a hole on a bottom of the cover body by the connecting nail; at least one convex platform is provided on an upper surface of the cover body; or two symmetrical grooves are provided on the upper surface of the cover body.

19. The spraying device of claim 17, wherein the node device further comprises a moving module, the moving module comprises a body module and a traveling module, the traveling module is installed on two sides of the body module, the liquid storage tank is detachably connected to a vehicle frame of the body module, and a rear end of a front housing of the body module is detachable connected to the front convex platform with the water conduit in the liquid storage tank by setting a rear end groove;
the cover comprises a cover body and a backstop, the cover body is an integral hollow structure, a side wall of the cover body is provided with threads, and at least one hole is provided on each of an upper side and a lower side of the cover body, the backstop comprises a connecting nail and a rubber sheet made of elastomer material, the connecting nail connected to a middle part of the rubber sheet; the backstop is connected to a hole on a bottom of the cover body by the connecting nail; wherein at least one convex platform is provided on an upper surface of the cover body; or two symmetrical grooves are provided on the upper surface of the cover body.

20. The spraying device of claim 19, wherein the front housing comprises a housing body and a cover plate, the cover panel is movably connected to the housing body; the housing body is a left-right symmetrical hollow cavity, a bottom of the housing body is provided with an air inlet, and a rear portions of two sides of the housing body are respectively provided with side connection recesses, a camera side connection hole is provided on each of a left side and a right side of the side connection recess, a camera with forward view and a camera with rear view are installed in the side connection recess by the camera side connection hole, an air outlet is provided above a middle part of the side connection recess, and a charging port interface is provided in the middle part of the side connection recess; an inner bottom surface of the housing body is provided with a controller installation slot, the controller is located in the controller installation slot, a power supply is connected to a bottom of the controller, the power supply provides power to the control system and is fixedly connected to the vehicle frame; the housing body is further provided with a headlight guide channel.
